(19) United States
(12) Patent Application Publication
(10) Pub. No.: US 2005/0211599 A1
(43) Pub. Date: Sep. 29, 2005

(54) Product comprising a hair-treatment composition and an item of information giving information about a measurable parameter associated with hair form

(75) Inventors: Roland De La Mettrie, Le Vesinet (FR); Didier Saint-Leger, Courbevoie (FR)

Correspondence Address: OLIFF & BERRIDGE, PLC, P.O. BOX 19928, ALEXANDRIA, VA, 22320, US

(73) Assignee: L'OREAL, Paris (FR)

(21) Appl. No.: 11/080,633

(22) Filed: Mar. 16, 2005

Related U.S. Application Data
(60) Provisional application No. 60/567,784, filed on May 5, 2004.

(30) Foreign Application Priority Data
Mar. 16, 2004 (FR) 0402727

(51) Int. Cl. B26B 19/14

(52) U.S. Cl. 206/581

(57) ABSTRACT

The present invention relates to a product including: i) at least one hair-treatment composition, and ii) at least a first item of information representative of at least one measurable parameter associated with the form of at least one hair from a head of hair for which said composition is suitable and/or from a head of hair likely to be obtained after applying the composition.

This non provisional application claims the benefit of French Application No. 04 02727 filed on Mar. 16, 2004 and U.S. Provisional Application No. 60/567,784 filed on May 5, 2004.

The present invention relates to characterizing natural or treated human hair, to methods and devices used for such characterization, and to products developed and/or used as a function of said characterization.

### BACKGROUND OF THE INVENTION

The article “Quantitative hair form variation in seven populations” published in AM. J. PHYS. ANTHROP., 39: 7-8 (1973) describes examples of parameters that can be used for characterizing hair from different populations in order to establish a possible genetic relationship between them.

The article “A study of the size and form of cross sections of hair from four races of men” published in AM. J. PHYS. ANTHROP., 19: 345-350 (1961) relates to a study on cross-sectional dimensions of hair in different populations.

The article “Preliminary study of hair form of Japanese head hairs using image analysis” published in the review, Forensic Science International (2003) 131: 202-208 describes acquiring an image of a hair by means of a scanner and calculating various parameters associated with hair form on the basis of the image thereby acquired. Such characterization is carried out within the framework of forensic investigation.

The work, “Atlas of human hair” by Robert R. Ogle, Jr. and Michelle J. Fox (1999) relates to identifying human hairs within a forensic framework. The authors describe using a Bailey and Schliebe gauge for measuring the degree of curvature of a hair.

Amongst other things, European patent No. 1 210 908, in the name of the Applicant, teaches using a scanner in order to obtain an image of a hair, and making a diagnosis on the basis of said image.

In order to be able to give the best advice to the person concerned, it is desirable to be able to characterize hair easily, before and/or after treating the hair, in particular, with a treatment other than coloring, and where appropriate, to be able to quantify the effectiveness of the hair-treatment compositions used or likely to be used.

It is also desirable to be able to have at least one hair-treatment product suitable for a particular hair form to be treated and/or for a particular hair form to be obtained after treatment.

### SUMMARY OF THE INVENTION

In one of its aspects, the invention provides a product comprising:
i) at least one hair-treatment composition, and
ii) at least a first item of information representative of at least one measurable parameter associated with the form of at least one hair from a head of hair for which said composition is suitable and/or a head of hair likely to be obtained after applying the composition.

The term “product” is not to be understood in a limiting sense and covers not only a composition and the receptacle that contains it, but also a kit including a package containing the above-mentioned receptacle and/or something else.

The term “measurable parameter” is used to designate a magnitude that can be obtained from at least one measurement carried out on hair, said measurement possibly being very approximate.

For example, the hair-treatment composition may be a permanent composition for permanently smoothing and/or straightening hair, or a composition for setting the hair, e.g. a hair styling gel. The composition may also be a shampoo. The hair-treatment composition may have an effect on hair form, and also, where appropriate, on hair color and/or brilliance. Said effect may be more or less long-lasting and/or more or less reversible.

The above-mentioned first item of information may be representative of at least two parameters, each associated with hair form, and one of which is at least measurable.

By way of example, said measurable parameter(s) is/are selected from the following:
a) the degree of curvature of at least one hair;
b) the degree of twist of at least one hair;
c) the degree of curl of at least one hair;
d) the degree of ellipticity of at least one hair; and
e) the average thickness of at least one hair.

The term “degree” should not be understood as being limiting in meaning. For example, each measurable parameter may take more than two values, may have more than two ranges of values associated therewith, or may pass through at least one intermediate value between two extreme values.

The product may also include a second item of information representative of at least one observable parameter associated with the form of at least one hair.

The term “observable parameter” is used to designate a parameter that can result from at least one observation of hair, without it being necessary to measure it. For example, an observable parameter may correspond to a state that is either found or not found on a particular hair.

For example, the observable parameter may be selected from:
a) the characteristic of being curly or not curly;
b) the characteristic of being wavy or not wavy.

A hair may be considered as presenting a curly characteristic when it forms at least half a turn when laid down flat.

A hair may be considered as presenting a wavy characteristic when its curvature changes direction at least once when said hair is laid down flat.

The product may also include a third item of information associated with the composition and representative of at least one parameter that is not associated with hair form. For example, said parameter not associated with hair form may be representative of the color and/or brilliance of the hair before or after treatment.

For example, the item of information may inform about at least one of the actual or desired color coordinates of the head of hair to be treated, in a calorimetric space, e.g. the CIE Lab space or the Munsell space, or about an intensity of shade in a scale of shade intensities.

The first, second, and third items of information may be expressed in various manners that are optionally directly comprehensible by an individual.

At least one of the first, second, and third items of information may comprise an identifier, for example.

For example, said identifier may include at least one item from: an alphanumeric character; a symbol; a drawing; a color; a bar code; and any other descriptor.

In an embodiment of the invention, the identifier comprises at least one alphanumeric character having a form that is representative of hair form before or after treatment. Said alphanumeric character is selected from the letters I, O, S, and C, for example.

Optionally, the identifier may include a number, for example, associated with an alphanumeric character as an index, said number being selected from: Arabic numerals, in particular 1 and 2; and Roman numerals, in particular I and II, for example.

In an embodiment of the invention, the product includes at least one analysis means, useful in particular for measuring at least one parameter associated with hair form.

For example, said analysis means is optionally included in a package with the hair-treatment composition. The analysis means and the hair-treatment composition may thus be disposed in different packages, for example.

For example, the analysis means may include at least one item from: a gauge; an atlas; a ruler; an optical magnifier device; a support suitable for holding a hair for observation; an electro-optical device; a lighting device, in particular, a unidirectional, optionally monochromatic, optionally polarized lighting device; a computer medium; and adhesive means for securing a hair. The computer medium may contain a program, e.g. a program for evaluating at least one parameter of the hair, e.g. by image analysis.

The product may also include at least one set of instructions explaining how to measure at least one parameter associated with hair form.

The product may also include at least one support onto which it is possible to secure hairs taken at different stages of a treatment using the product, in order to enable the user to observe the effect of the treatment.

The product may also include packaging for receiving a hair before and/or after treatment by said product, for sending to a remote analysis center. Where appropriate, the packaging may be pre-paid.

The product may also include at least two pictures of hair and/or of heads of hair and, in connection with said pictures, at least two items of information representative of at least one parameter associated with hair form, better at least two parameters associated with hair form. For example, said pictures may appear on a package or on a receptacle containing the hair-treatment composition or on an explanatory leaflet. For example, said pictures may enable consumers to determine their own hair type more easily prior to purchase. In a variant, they may show an effect on hair form produced by the hair-treatment composition.

The invention also provides a correspondence table serving to establish a connection between brands and/or marketing references of hair-treatment compositions and at least one item of information about a measurable parameter associated with hair form, or about at least two parameters associated with hair form.

The product may also include the electronic address of a web site or the telephone number of a server to which an image of at least one hair can be sent, e.g. for analysis.

The product may include a composition for treating, in particular for cleaning, the hair before measuring and/or observing at least one parameter associated with its form. Said composition may contain a wetting agent, for example, in order to remove all traces of previously-used hair-treatment compositions or impurities from the hair. Said composition may also come in the form of a moist tissue.

In another of its aspects, the invention also provides a range of products including at least first and second products as defined above, the first product including a first item of information that is different from the first item of information of the second product.

Independently or in conjunction with the above, the invention also provides a product comprising:
i) at least one hair-treatment composition,
ii) at least one item of information about at least two parameters associated with the form of at least one hair, in particular a hair from a head of hair for which said composition is suitable and/or from a head of hair likely to be obtained after applying the composition.

One of the two parameters may be a measurable parameter, for example.

Independently or in conjunction with the above, the invention also provides a product comprising:
i) at least one hair-treatment composition,
ii) at least one alphanumeric character or one graphic having a form representative of hair form from a head of hair for which said composition is suitable and/or from a hair from a head of hair likely to be obtained after applying the composition.

Said alphanumeric character is selected from the letters I, O, S and C, for example. Where appropriate, the identifier may also include a number associated with the alphanumeric character. Said number may be selected from: Arabic numerals, in particular 1 and 2; and Roman numerals, in particular I and II.

Independently or in conjunction with the above, the invention also provides a product comprising:
i) at least one hair-treatment composition,
ii) at least one analysis means for measuring at least one measurable parameter associated with hair form.

The analysis means includes at least one item from: a gauge; an atlas; a ruler; an optical magnifier device; a support capable of holding a hair for observation; an electro-optical device; a lighting device, in particular a unidirectional, optionally monochromatic and optionally polarized lighting device; a computer medium; and adhesive means for securing a hair.

Independently or in conjunction with the above, the invention also provides a product comprising:
i) at least one hair-treatment composition,
ii) at least two pictures of hairs and/or of heads of hair and, in connection with each picture, at least one item of information representative of at least one parameter associated with hair form.

Independently or in conjunction with the above, the invention also provides a product comprising:
i) at least one hair-treatment composition,
ii) packaging for receiving a hair before or after treatment with the composition. Said packaging may be pre-paid.

Independently or in conjunction with the above, the invention also provides a product comprising:
i) at least one hair-treatment composition,
ii) at least one set of instructions explaining how to determine at least one parameter associated with hair form. Said parameter may be measurable or observable.

Independently or in conjunction with the above, the invention also provides a computer system organized:
to receive at least one electronic image of at least one hair from a subject;
to analyze the image so as to determine at least one parameter associated with hair form, better, at least two parameters at least one of which is a measurable parameter; and
to deliver at least one item of information representative of said parameter to the subject.

Said item of information may help said subject in selecting a hair-treatment composition suitable for the head of hair from which the hair appearing on the electronic image comes, or suitable for obtaining a particular result.

Moreover, said system may be organized so as to recommend at least one hair-treatment composition suitable for the head of hair from which the hair comes.

The system may also be organized so as to initiate dispatch of the hair-treatment composition to the subject, in particular via a central distribution agency.

Independently or in conjunction with the above, the invention also provides an atlas comprising:
at least two pictures and/or samples of heads of hair;
at least a first item of information associated with each picture and/or each sample, representative of at least one parameter associated with hair form, in particular at least one parameter that is measurable, e.g. at least one measurable parameter and one observable parameter.

Said measurable parameter may be selected from the following, for example:
a) the degree of curvature of at least one hair;
b) the degree of twist of at least one hair;
c) the degree of curl of at least one hair;
d) the degree of ellipticity of at least one hair; and
e) the average thickness of at least one hair.

The first item of information may include an identifier. Said identifier may include at least one item from: an alphanumeric character; a symbol; a drawing; a color; and a bar code. In particular, the identifier may include at least one alphanumeric character having a form that is representative of hair form before or after treatment.

The atlas may be printed at least in part or, in a variant, may be displayed or projected on a screen at least in part.

For example, the atlas may be used to characterize a hair by comparing said hair with different pictures and/or different samples from the atlas.

The atlas may be used for the professional training of hairdressers, for example, or it may be used to draw up a map of different hair types throughout the world.

Independently or in conjunction with the above, the invention also provides an atlas comprising:
at least two two-dimensional (2D) pictures of a hair;
at least a first item of information associated with each picture and representative of at least one measurable parameter associated with hair form.

The term “2D picture” is used to designate a two-dimensional picture of a hair other than a cross-section of the hair. The picture may be of the hair as it appears when pressed against a flat support, or when free and merely photographed by a camera.

Independently or in conjunction with the above, the invention also provides a method of characterizing a head of hair when advising a consumer, and/or when studying the effects of a hair-treatment composition, and/or when promoting a hair-treatment composition, and/or when training professionals, such as hairdressers or beauticians, in which at least one measurable parameter associated with hair form is determined, and/or in which at least two parameters associated with hair form are determined.

For example, said determination entails at least one measurement selected from: measuring the length of the hair at rest and in a stretched state; and measuring the curvature of the hair, its average thickness, its ellipticity, and the spatial frequency of a given variation in the appearance of the hair, in particular, in its apparent thickness and/or its local curvature.

The method of characterizing the head of hair may be implemented manually, or in an automated or semi-automated manner.

The result of characterization may be issued in writing or orally.

Optionally, the method of characterization may be followed by giving advice. Said advice may comprise, for example, recommending at least one hair-treatment composition affecting the measurable parameter concerned. The composition may be for hair treatment other than a coloring treatment, e.g. a permanent composition for permanently smoothing and/or straightening hair.

Advantageously, the measurement(s) may be taken with the naked eye, without an optical magnifier device, which makes the method easy to implement. In a variant, an optical magnifier device may be used.

For example, said measurable parameter may be selected from:
a) the degree of curvature of at least one hair;
b) the degree of twist of at least one hair;
c) the degree of curl of at least one hair;
d) the degree of ellipticity of at least one hair; and
e) the average thickness of at least one hair.

The above parameters may be determined on the basis of a single hair or of a plurality of hairs, e.g. three hairs taken from a single head of hair. Where appropriate, the results of the measurements taken on a larger number of hairs may be subjected to statistical processing, e.g. in order to find the average of the measured values.

For example, the degree of curvature may be determined on the basis of measuring the diameter of curvature of at least a portion of the hair.

The diameter of curvature may be measured by using a gauge or by analyzing an image, for example.

For example, the degree of twist may be determined by counting the number of twists per unit length of the hair. In order to determine the number of twists, the hair is advantageously observed under grazing light while in a substantially stretched state.

For example, the degree of curl may be determined by measuring the maximum length (L₂) of the hair and its length (L₁) at rest. A curl index may be determined as being the ratio L₂/L₁.

The mean thickness and/or the degree of ellipticity may be determined, for example, by measuring the dimensions of a cross-section of the hair, examined under a microscope or a binocular magnifier.

The method of characterization may comprise taking at least one hair, determining a diameter of curvature of at least a portion of said hair, measuring its length at rest, measuring its length in a substantially stretched state, and observing it, preferably under grazing light, in a substantially stretched state in order to determine the number of twists per unit length.

Moreover, the method may include determining the wavy or non-wavy characteristic of the hair, and the curly or non-curly characteristic of the hair.

An identifier may be attributed to the hair, said identifier being selected from six identifiers, for example, a first identifier for “straight hair” corresponding to hair having a diameter of curvature at rest that is not less than a first predefined threshold value, e.g. 80 centimeters (cm); a second identifier for “curved hair” corresponding to hair having slight curvature, in particular a diameter of curvature that is less than the first threshold value, the hair not presenting any wavy characteristic nor any curly characteristic; a third identifier for “slightly wavy hair” corresponding to hair having a diameter of curvature that is, for example, not less than a second predefined threshold value, e.g. 5 cm, and presenting a wavy characteristic; a fourth identifier for “very wavy hair” corresponding to hair presenting a wavy characteristic and a diameter of curvature that is less than the second threshold value; a fifth identifier for “slightly curly hair” corresponding to hair presenting a curly characteristic and a diameter of curvature that is not less than the second threshold value; and a sixth identifier for “very curly hair” corresponding to hair presenting a curly characteristic and a diameter of curvature that is less than the second threshold value.

The result of characterization may be recorded in a data base with at least one item of information relating to the person from whom the hair was taken.

Independently or in conjunction with the above, the invention also provides a method of revealing the effectiveness of a hair-treatment composition including steps consisting in:
i) attributing to a head of hair at least one measurable parameter associated with its hair form;
ii) carrying out treatment with the composition;
iii) renewing step i) on the head of hair treated in ii).

Comparison of the parameters in i) and iii) can give information about the effect of the composition on hair form.

Independently or in conjunction with the above, the invention also provides a method of recommending a hair-treatment composition including steps consisting in:
i) enabling the acquisition of at least a first item of information representative of at least one measurable parameter associated with the form of at least one hair from a head of hair to be treated; and
ii) as a function of the information obtained in i), determining a composition to use.

Said recommendation method may be implemented at a sales outlet, for example, or remotely via a computer network, in particular an Internet, intranet, or mobile telephone network.

Where appropriate, after step ii) a product suitable for obtaining a desired result is handed or sent to the user.

The product may be supplied via any sales channel, in particular, by being sold in a store, or by mail order, or in a beauty salon, or in a hairdresser's, for example.

Independently or in conjunction with the above, the invention also provides a device for characterizing the degree of twist of at least one hair, the device comprising:
a support serving to hold the hair in a substantially stretched state;
a source of optionally monochromatic and optionally polarized light serving to illuminate the hair in a direction that is substantially perpendicular to an observation direction for observing the hair.

In particular, the hair may be illuminated in a direction that is substantially parallel to the support.

For example, the hair may be held against the support in a substantially stretched state by means of adhesive tape.

The device may include a slit, preferably orientated substantially parallel to the hair, with the light source emitting through the slit.

Independently or in conjunction with the above, the invention also provides a method of characterizing the degree of twist of at least one hair, the method comprising:
illuminating a length of hair held in a substantially stretched state; and
determining a magnitude representative of a variation in appearance of the hair over its length, for example a spatial frequency of variation in appearance of the hair, in particular in its apparent thickness and/or its brilliance.

The invention also provides a hair-treatment method, including the following steps:
associating a consumer with an identifier representative of at least one measurable parameter associated with the form of at least one hair of said consumer;
as a function of said information, selecting at least one hair-treatment product from a number of products identified by corresponding identifiers;
treating the consumer with the selected product(s).

The invention also provides a method of characterizing at least one hair, in which at least the degree of twist of the hair is determined.

The invention also provides a device for determining a parameter that is representative of a degree of curl of at least one hair.

For example, the device may comprise a body including a graduated scale and a securing member for securing the hair onto the body, said graduated scale serving to measure the length of the hair L₂ in a substantially taut state and the length L₁ of the hair at rest.

Where appropriate, the device may include manual or electronic calculating means e.g. a micro-computer, a calculator, an abacus, a ruler or a table serving to give information based on the values L₂ and L₁ that is representative of the degree of curl. The device may in particular be arranged to calculate the ratio L₂/L₁ automatically and to supply the corresponding index.

The invention also provides a method of promoting sale of a hair-treatment composition, in particular a permanent composition for permanently straightening and/or smoothing the hair, which method takes account of information representative of at least one measurable parameter associated with hair form or at least two parameters associated with hair form.

For example, said information may inform about the effectiveness of the composition, in particular in terms of variation in a measurable parameter or it may inform about a characteristic of at least one head of hair for which said composition is suitable, or it may inform about a result that can be obtained.

The product may be promoted via any communications channel. In particular, it may be promoted directly by a sales person at a sales outlet, over the radio, television, or telephone, in particular in commercials or short messages (SMS). It could also be promoted via the press or any other document, in particular for advertising purposes. It could also be promoted on the Internet, via any other suitable computer network, or via a mobile telephone network. It could also be promoted directly on the product, in particular on its packaging or on any other explanatory leaflet associated with said product.

The invention also relates to, independently or in combination with the preceding objects, a device for characterizing the degree of curvature of at least one hair, comprising an information support such as a gauge, the support having at least one transparent zone and comprising a plurality of circular arcs and/or circles having different diameters, in particular printed, in the transparent zone of the support.

The support may be for instance a transparent sheet.

The invention also relates to, according to another of its aspects, a method for characterizing the degree of curvature of at least one hair by means of the device disclosed above, the method comprising:
placing the support on the hair such that the hair appears through the transparent zone of the support,
comparing the curvature of the hair with the circular arcs and/or the circles of the support in order to determine a degree of curvature of the hair.

### BRIEF DESCRIPTION OF THE DRAWINGS

The invention will be better understood on reading the following detailed description of non-limiting embodiments and implementations thereof, and on examining the accompanying drawings, in which:

FIG. 1 is a diagram showing a gauge that can be used to determine the degree of curvature of a hair;

FIG. 2 is a diagrammatic perspective view showing a device serving to determine the degree of twist of a hair;

FIG. 3 shows the use of the device of FIG. 2;

FIG. 4 is a diagrammatic elevation view showing a device serving to determine the degree of curl of a hair;

FIG. 5 shows how an image of a hair is analyzed;

FIG. 6 shows how the degree of ellipticity can be determined;

FIGS. 7 to 9 show embodiments of atlases made in accordance with the invention;

FIG. 10 shows an example of an identifier;

FIG. 11 shows an example of a product comprising a hair-treatment composition and an instructions leaflet;

FIG. 12 shows an example of a product comprising a hair-treatment composition and means for analyzing a hair;

FIG. 13 shows an example of a product comprising a hair-treatment composition, and an associated atlas;

FIG. 14 shows an example of a product comprising a hair-treatment composition and packaging serving to send at least one taken hair to an analysis center;

FIG. 15 shows an example of a correspondence table of products and identifiers;

FIG. 16 shows an example of a table giving results as a function of applied treatment;

FIG. 17 shows a range of products associated with various identifiers;

FIG. 18 shows a computer system that can be used to send an image of a hair to a analysis center and/or to receive advice;

FIG. 19 is a diagram showing a support that can be used to compare hairs at different steps during treatment, and

FIG. 20 shows diagrammatically a transparent gauge according to the invention.

### MORE DETAILED DESCRIPTION

Degree of Curvature of a Hair

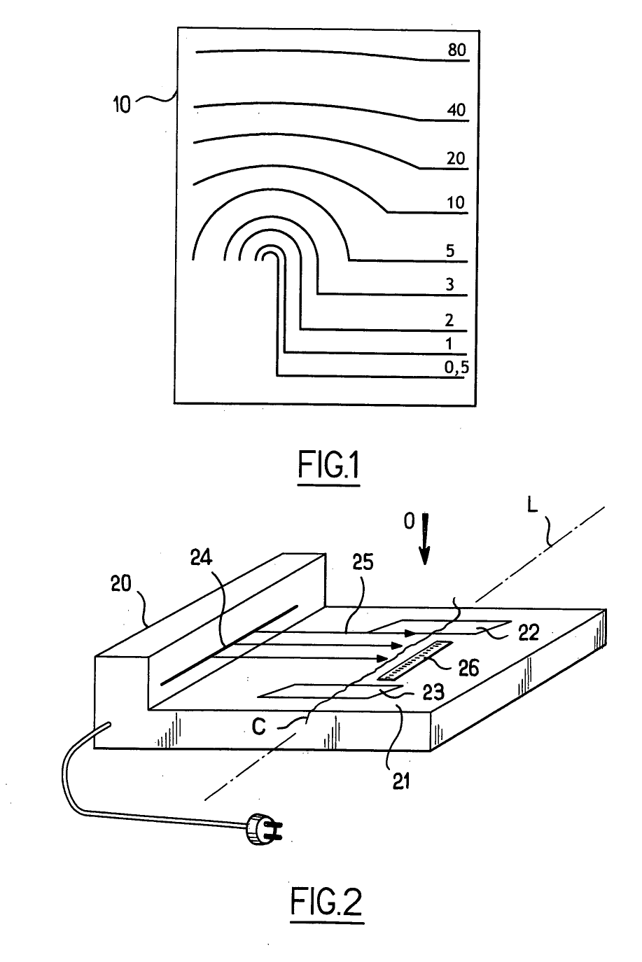

In order to characterize the degree of curvature of a hair, any information tool may be used, e.g. the so-called Bailey and Schliebe gauge 10, such as that shown in a diagram in FIG. 1, which has circular arcs of various diameters e.g. 0.5 cm, 1 cm, 2 cm, 3 cm, 5 cm, 10 cm, 20 cm, 40 cm and 80 cm, respectively.

The gauge 10, or any other information tool performing the same role, may be a printed document, or may be displayed or projected on a screen. The arcs may also be raised, or in the form of perforations.

In order to measure the degree of curvature of a sample hair, it is possible, for example, to secure the root end of the hair onto a piece of paper by means of an adhesive strip or a Post-it®, and then optionally flatten it, by placing a transparent object on top of it, for example. The color of the sheet of paper is advantageously selected on the basis of the color of the hair in order to maximize visual contrast. For example, it is possible to use a piece of white paper for dark hair, and a piece of black paper for blond or white hair.

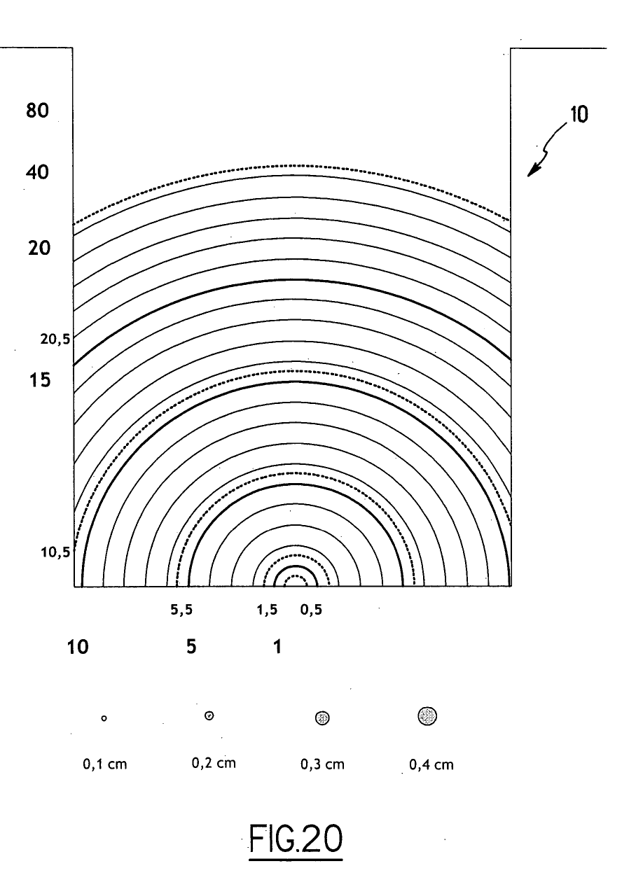

The gauge 10 may for instance be a transparent sheet on which circular arcs and/or circles of different diameters are printed, as illustrated in FIG. 20.

In order to measure the degree of curvature of a hair by means of the transparent gauge 10, the gauge 10 is such as to flatten it and the curvature of the hair is compared to the circular arcs and/or the circles.

Where appropriate, the length L₁ of the hair at rest may be measured at the moment when its degree of curvature is determined. When the diameters differ greatly, the longest diameter is preferably retained.

Preferably, a portion of recent hair is characterized, e.g. the portion extending for a length lying in the range of 5 cm to 10 cm from the root, for example. Said length may be selected as 5 cm, for example.

The degree of curvature may also be measured by analyzing an image, e.g. an image of a hair obtained by means of a photocopier, of a scanner, of a camera or of a digital camera. It is easy to calculate curvature at any point of a curved line extending in a plane.

Wavy Characteristic

It is also possible to determine the characteristic whereby the hair is wavy or not wavy, as defined above, merely by observing it.

Curly Characteristic

This is another observable parameter, as defined above, that can be determined.

Examples of Identifiers that Give Information about the Degree of Curvature and about the Characteristics of Being Wavy or not Wavy, and of being Curly or not Curly

Depending on the diameter measured and on the wavy or not wavy characteristic of the hair, on the curly or not curly characteristic of the hair, various identifiers can be attributed to the hair in order to characterize a hair type in general manner, for example.

For example, there may be attributed:
a first identifier to hair having a diameter of curvature at rest that is not less than 80 cm;
a second identifier to hair having a curvature that corresponds to a diameter of curvature of less than 80 cm, but does not present any wavy or curly characteristic;
a third identifier to hair having a diameter of curvature not less than 5 cm, and presenting a wavy characteristic;
a fourth identifier to hair having a diameter of curvature of less than 5 cm, and presenting a wavy characteristic;
a fifth identifier to hair having a diameter of curvature not less than 5 cm, and presenting a curly characteristic;
a sixth identifier to hair having a diameter of curvature of less than 5 cm, and presenting a curly characteristic.

For example, the first to sixth identifiers may be letters, numbers or combinations of the two, even symbols or other descriptors, e.g. in the form of words, sentences, drawings, or logos, that are directly comprehensible by an individual, or, in a variant, they may be in a form that is not directly comprehensible by an individual, such as a bar code or data stored in a file, or in an electronic memory, for example.

In an embodiment of the invention, for example, identifiers one to six comprise the Roman numerals I to VI, respectively.

Identifiers one to six may include respective descriptors e.g. “straight hair”, “curved hair”, “slightly wavy hair”, “very wavy hair”, “slightly curly hair” and “very curly hair”.

Identifiers one to six may also include at least one letter having a shape or form that evokes hair form.

Where appropriate, said letter may be followed by an index number, for example, in order to give information about the more or less pronounced characteristic of a feature of the hair.

For example, the first identifier may be I, the second identifier C, the third identifier S₁, the fourth identifier S₂, the fifth identifier O₁, and the sixth identifier O₂.

Degree of Twist

This is another parameter that is measurable in the meaning of the invention, which, where appropriate, may characterize a hair yet more precisely and, in particular, the rotation of the major axis in cross-section.

In order to determine the degree of twist, variations in appearance of the hair per unit length may be recognized when the hair is in a substantially stretched state, in particular, variations in its apparent thickness and/or its brilliance.

In order to make it easier to observe said variations in appearance, a device, such as the device referenced 20 in FIG. 2, may advantageously be used, said device including a support 21 over which a hair C may be placed, said hair being held in a substantially stretched state by securing members 22 and 23 constituted by adhesive tape, for example, that are secured to the support 21.

Preferably, in order to improve precision, a length of hair C is used which, when stretched, measures at least 5 cm, and it is preferable to use the first 5 cm to 10 cm from the root.

The device 20 has a source of light (not shown) that is arranged so as to illuminate the hair, preferably over its entire length, under grazing light.

For example, the source emits via a slit 24 oriented parallel to the plane of the support 21. The emitted beam of light 25 extends in a direction that is substantially parallel to the plane of the support 21 and substantially perpendicular to the longitudinal axis L of the hair.

When the source of light is artificial, said source of light may include an incandescent lamp or a fluorescent lamp, for example, or even a succession of light-emitting diodes (LEDs).

The device 20 may include a graduated scale 26 extending along the hair C.

By observing the hair C under grazing light in an observation direction O that is substantially perpendicular to the plane of the support 21 it is possible to detect substantially periodical variations in the appearance of the hair, in particular, narrowings in its thickness.

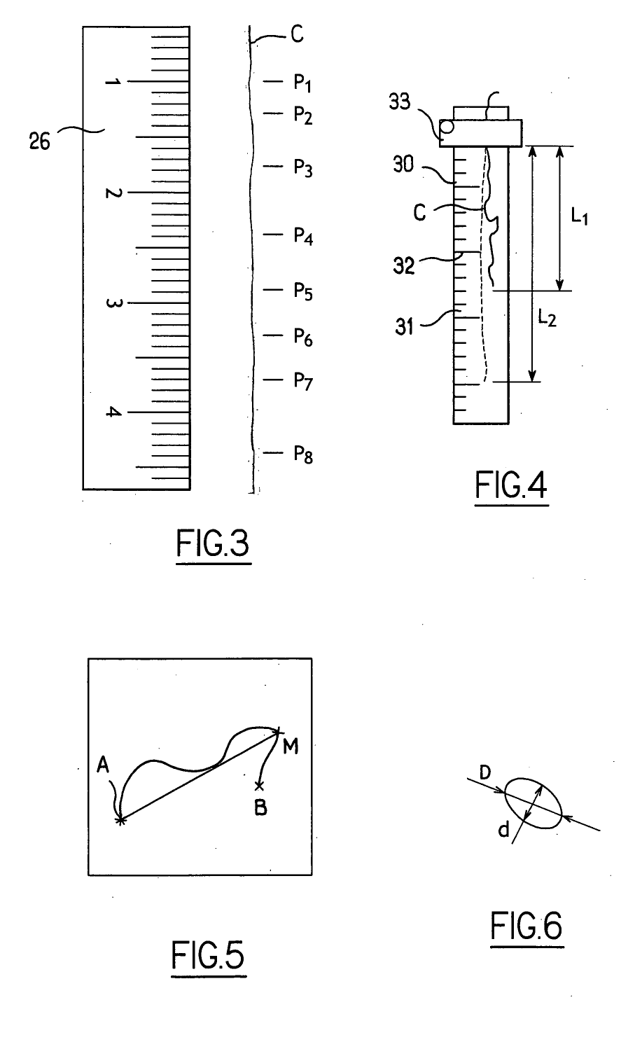

Eight narrowings P1 to P8 can be seen in the example considered in FIG. 3, said narrowings extending between the portions of thicker appearance.

It is possible to determine the degree of twist of the hair by calculating the number of narrowings per unit length, for example.

Thus, in the example in FIG. 3, it is possible to count eight narrowings over a distance of about 3.4 cm measured between the extreme narrowings P1 and P8, which corresponds to a twist intensity of 8/3.4=2.35.

Of course, the invention is not limited to a particular device serving to determine the degree of twist and, for example, it is possible to hold the hair C in a stretched state on or above the support 21 by means other than adhesive tape e.g. by means of weights, magnets, clips or even manually.

Where appropriate, the color of the support 21 may be selected on the basis of the hair color, so as to facilitate observation.

Natural or artificial lighting may be used as the source of light.

When natural lighting is used, for example it is possible to place a screen beside the hair, said screen being arranged so that said hair receives light in an essentially grazing manner.

Where appropriate, the device used may be arranged so that it is possible to acquire an image of the hair in a stretched state, for example by means of a scanner, of a photocopier, of a digital camera, or of a camera, such an image optionally being sent by a computer network to a server for processing the image in order to determine the degree of twist. It is also possible to determine the degree of twist of the hair from analyzing an image of said hair.

Said degree may also be determined by calculating the spatial frequency of a variation in appearance of the hair other than a variation in its apparent thickness, e.g. a variation in its local curvature or in its brilliance.

The pressure exerted on the hair may be adjusted in order to facilitate observation of repeated variations in the appearance of the length of hair.

With hair that is short or very short, it is possible, for example, to determine a degree of twist, if any, by measuring the distance separating two substantially identical variations in hair appearance, e.g. two narrowings.

An identifier may be attributed to the hair, which identifier may be qualified as a “sub-type” expressing the degree of twist; e.g. a letter that represents a range of values of degrees of twist.

For example, the identifier a may be attributed when the degree of twist is nil or less than 0.1, the identifier b when the degree of twist is low, i.e. greater than 0.1 but not greater than 1, the identifier c when the degree of twist is high, lying in a range 1 to 2, and the identifier d when the degree of twist is very high, i.e. greater than 2.

Of course, it is possible to adopt other ways of identifying the degree of twist without departing from the ambit of the present invention.

For example, it is possible to measure an average length of twist, said length being defined as the length of a portion of greater apparent thickness extending between two narrowings.

The degree of twist may then be defined on the basis of the average length of twist.

Degree of Curl

In order to determine the degree of curl, a device may be used, such as that shown in FIG. 4 and referenced 30.

Said device 30 has an elongate body 31 provided with a graduated scale 32 along which a hair may be extended.

Said hair may be secured at one end to the body 31 by means of a securing member 33 that grips the hair, for example.

The device 30 serves for measuring the length L₁ of the hair at rest, and its length L₂ in a substantially stretched state, the hair being stationary relative to the body 31 in the vicinity of the securing member 33.

The curl index i may be determined by the ratio L₂/L₁.

The degree of curl may also be easily calculated from an image of the hair, such as the image in FIG. 5, for example.

The length L₁ at rest corresponds to the distance between A and M, M being the point of the hair farthest from A when M moves from A to B, A and B being the two ends of the hair. L₁=max d(A, M) for M moving from A to B. There is also:

$${L}_{2} = {\int }_{A}^{B} ⅆ l .$$

Degree of Ellipticity, or Average Thickness

In order to determine the degree of ellipticity, it is possible to evaluate the ratio D/d, for example, where D and d are long and short diameters of the hair, respectively, as shown in FIG. 6.

Average thickness is given as: (D+d)/2.

The long and short diameters may be measured with a microscope or a binocular magnifying glass, for example.

Combination of Identifiers

The various identifiers above may be combined, as shown in FIG. 10, for example, in order to constitute information about the curl type, sub-type and rating, for example, or about the curl type and rating.

Other Parameters not Associated with Hair Form

It still lies within the ambit of the present invention to determine parameters other than those relating to hair form e.g. its color, as stated above.

Atlas

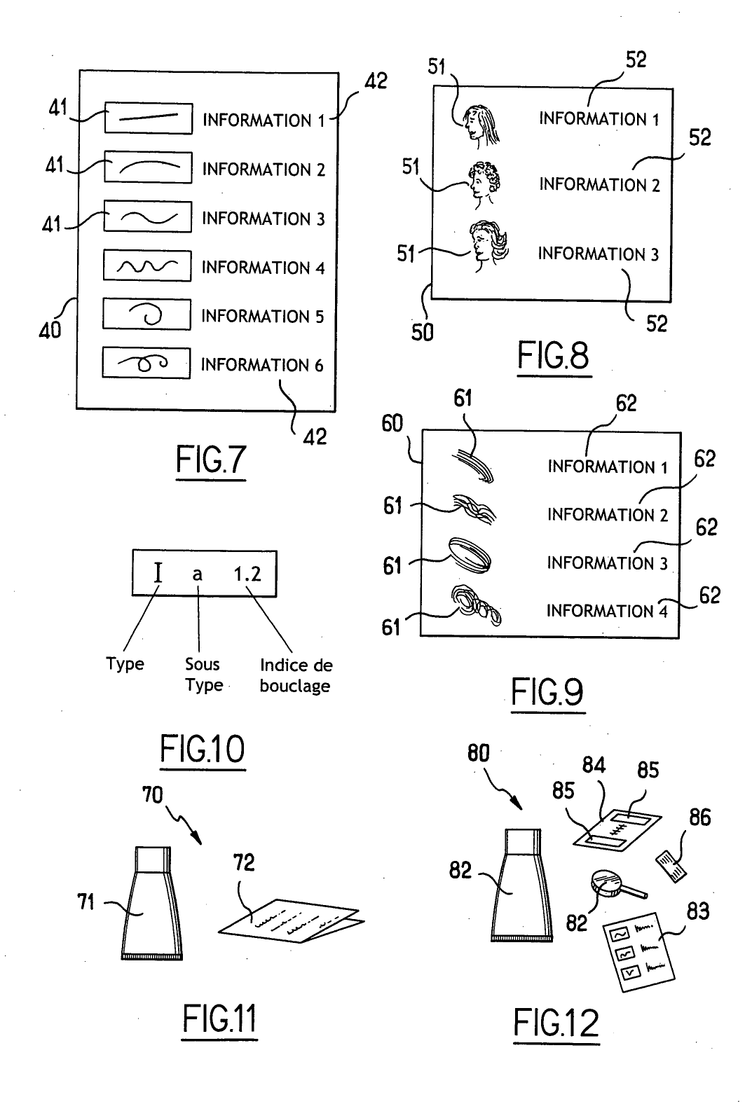

The invention makes it possible to make up atlases such as those shown in FIGS. 7 to 9, for example.

The atlas 40 shown in FIG. 7 has a plurality of pictures of isolated hairs associated with corresponding information 42 about at least one parameter associated with hair form that is the subject of the corresponding picture, in particular, a measurable parameter.

For example, the atlas 40 may show six pictures of hair corresponding to the six types I to VI mentioned above, and the information 42 may include the respective identifiers I to VI, or the letters O, S, C, I, optionally associated with a certain index 1 or 2, as mentioned above.

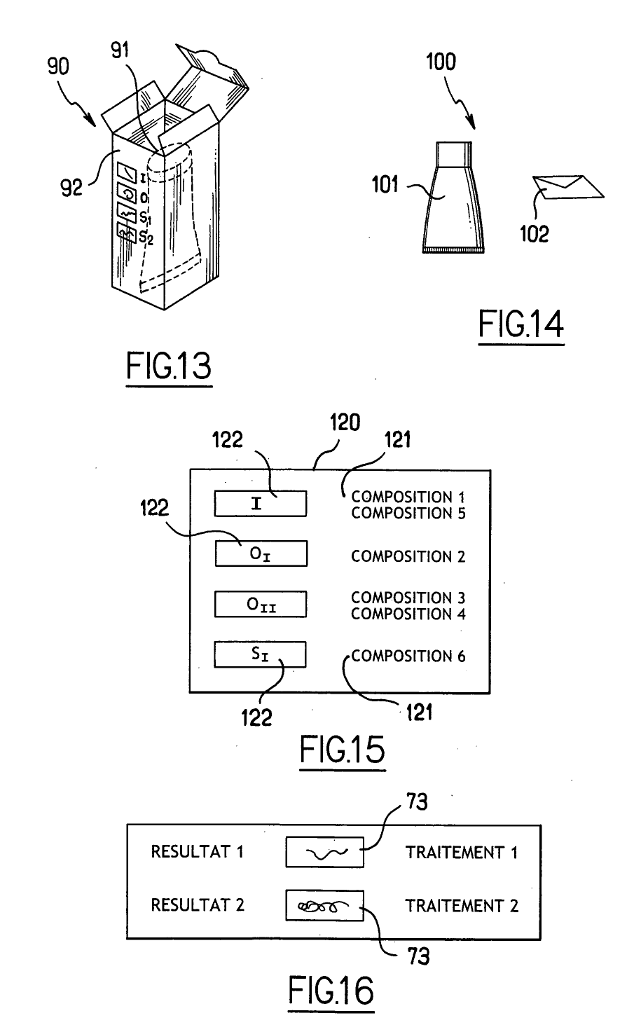

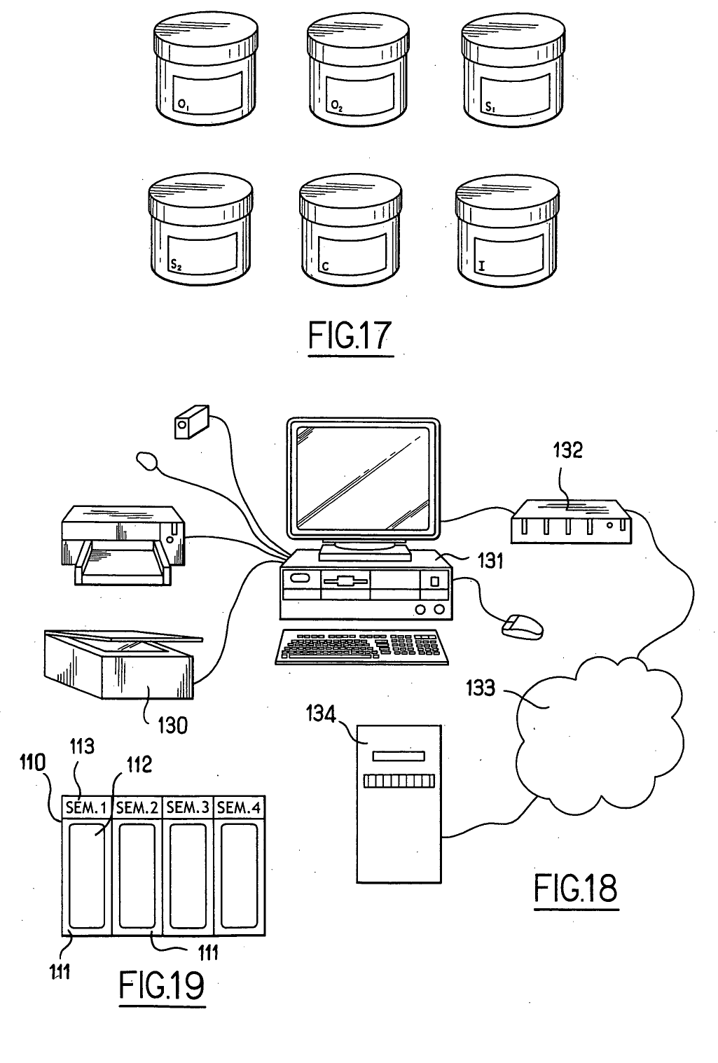

The atlas 50 shown in FIG. 8 has pictures 51 of whole heads of hair, or portions of heads of hair, and the corresponding information 52 about at least one measurable parameter associated with a hair form taken from said heads of hair.

The atlas 60 shown in FIG. 9 has a sampler of locks of hair made up of a plurality of locks 61 of hair, and each lock of hair is associated with information 62 about at least one parameter relating to the form of at least one hair extracted from the corresponding lock of hair.

Examples of Products

Advantageously, the invention may serve to associate at least one hair-treatment composition with at least one item of information representative of at least one measurable parameter or at least one observable parameter associated with the form of at least one hair.

The term “hair-treatment composition” is used to mean any composition for treating hair used by consumers themselves, or by professionals such as hairdressers, dermatologists, or beauticians. For example, said use may be connected with training based on classifying the hair, or on using a descriptive information medium for said classification.

As shown in FIG. 17, it is possible to make up at least one product comprising a hair-treatment composition and a receptacle for containing said composition, said receptacle carrying at least one selected identifier, for example, from amongst those mentioned above, and informing the user about the type of hair for which the product is suitable and/or the type of hair that can be obtained following treatment with said composition, for example.

In the example in FIG. 17, a range of products is shown, in which the products are allocated to the identifiers O₁, O₂, S₁, S₂, C, and I, respectively, in order to indicate to the consumer the type of hair for which each product is suitable or the type of result said consumer is likely to obtain with the composition.

As shown in FIG. 11, the invention also makes it possible to make up a product 70 comprising, firstly, a receptacle 71 containing a hair-treatment composition and, secondly, an information medium 72 containing at least one set of instructions directing the user as to how to determine at least one measurable parameter or at least one observable parameter associated with hair form.

For example, the information medium 72 may encourage the user to connect to an internet site or to a vocal server, and may include an address and/or telephone number for this purpose. The information medium 72 may also inform the user how to calculate a curl rating, how to determine the degree of twist, or how to measure the diameter of curvature of a hair.

For example, the information medium 72 may include a measurement 10, such as that shown in FIG. 1.

For example, the information medium 72 may also include an atlas similar to either of those shown in FIGS. 7 and 8, to enable users to evaluate their hair type, and thus benefit from said information for a subsequent purchase.

For example, the information medium 72 may also include a table such as that shown in FIG. 16, including at least two pictures 73 of hair or hairs corresponding to two results from treatment with the composition contained in the receptacle 71, depending on the quantity of composition used or its method of application, for example.

For example, each result corresponding to a picture 73 may be identified by an identifier, e.g. one of those mentioned above.

For example, if the composition makes it possible to curl the hair, one treatment result may be identified by the identifier O1, for example, and another result by the identifier O2, in order to indicate to the user that in one event more strongly curled hair is obtained than in another.

The information medium 72 may also include set of instructions to direct users on how to acquire an image of one of their hairs by means of a photocopier, of a scanner, of a digital camera, or of a camera, for example, in order to send it to a remote analysis center, in order to receive advice in return on how to use the composition, for example.

The product 80, shown diagrammatically in FIG. 12, includes at least one receptacle 81 that contains a hair-treatment composition and at least one means for analyzing a parameter associated with hair form.

FIG. 12 shows only a few examples of the analysis means that can be used, amongst others.

For example, there may be an optical magnification 82 device, such as a magnifying glass, an atlas 83 that is similar, for example, to the atlases shown in FIGS. 7 and 8, a support 84 serving to hold at least one hair in a substantially stretched state so that it can be observed under grazing light and its degree of twist can be determined, said support 84 including two adhesive tapes 85, for example, serving to hold the ends of the hair securely to said support.

Analysis means, such as a gauge or a ruler, may also be used.

Where appropriate, said analysis means may also include a cleaning composition and/or preparatory composition for observation, said composition being contained in a capsule 86, for example, in order to clean the hair or to subject it to chemical treatment prior to observing it.

For example, in addition to at least one receptacle 91 containing said composition, the product 90 shown in FIG. 13 includes an atlas which may appear on packaging 92 in which the receptacle 91 is contained.

For example, said atlas may be similar to one of the atlases in FIGS. 7 and 8 and enable the consumer or the professional to determine the identifier that corresponds to a hair before proceeding to buy and/or apply a suitable hair-treatment composition.

The product 100 shown in FIG. 14 comprises at least a receptacle 101 containing a hair-treatment composition and packaging 102 enabling the user to send at least one hair to a remote analysis center with the aim of receiving in return advice on the use of the hair-treatment composition or an item of information about at least one parameter associated with hair form, for example.

Where appropriate, the packaging 102 may be pre-paid.

The product may also include at least one receptacle containing a hair-treatment composition and a support 110 such as the support shown in FIG. 19, making it possible to keep at least two hairs taken at different moments from the hair of the user, with the aim of comparing the effects of a treatment over time, for example.

For example, said support 110 may include a plurality of regions 111, each region allowing a transparent adhesive strip 112 to be positioned, said strip being for covering a hair after it has been taken. For example, each region 111 may be associated with an item of information 113 relating to the moment when the hair should be taken, or merely serving to remind about the order in which the hairs have been taken.

Where appropriate, hair-treatment compositions for exerting an action on hair forms may be contained in receptacles that do not include any information informing the user about any measurable parameter associated with hair form, but instead that do include the trade marks and/or commercial references 121 of said compositions, which, where appropriate, may be well known. These can appear in a table 120, *with each composition being associated with an item of information 122 representative of at least one measurable parameter associated with the hair form for which said composition is suitable and/or the hair form said composition is suitable for obtaining. For example, item of information 122 is conveyed by one of the above-mentioned identifiers O, S, C, and I.

FIG. 18 shows a computer system which comprises, for example, a scanner 130 connected to a micro-computer 131, said micro-computer being connected to a computer network 133, such as the internet, for example, by a modem 132 in order to enable the user to send at least one image of a hair to a computer system 134. The computer system 134 is organized to analyze said image and to determine at least one degree of curvature and one degree of curl, for example.

In return, the computer system 134 can deliver an item of information to users enabling them to know their hair type and, where appropriate, a sub-type or any other item of information representative of a measurable parameter or an observable parameter that is associated with hair form.

Users may also receive advice about using at least one composition that is suitable for their hair or a recommendation about one or more compositions that are suitable for their hair.

For example, users may also ask the computer system 134 about the type of hair that they would like to obtain, and, in return, the computer system 134 can deliver information concerning the hair-treatment compositions that make it possible to achieve said result.

The invention can facilitate the design and the choice of products suitable for given hair.

Of course, the invention is not limited to the embodiments described above.

Throughout the description, including in the claims, the expression “comprising a” should be understood as being synonymous with “comprising at least one”, unless specified to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A product comprising:
i) at least one hair-treatment composition; and
ii) at least a first item of information representative of at least one measurable parameter associated with a form of at least one hair from at least one of a head of hair for which said composition is suitable and a head of hair likely to be obtained after applying the composition.

2. A product according to claim 1, wherein the hair-treatment composition comprises at least one of a permanent composition for permanently smoothing hair, a composition for straightening hair and, a composition for setting the hair.

3. A product according to claim 1, wherein the first item of information is representative of at least two measurable parameters associated with hair form.

4. A product according to claim 1, wherein the at least one measurable parameter is selected from the following:
a) a degree of curvature of at least one hair;
b) a degree of twist of at least one hair;
c) a degree of curl of at least one hair;
d) a degree of ellipticity of at least one hair; and
e) an average thickness of at least one hair.

5. A product according to claim 1, further comprising a second item of information representative of at least one observable parameter associated with the form of at least one hair.

6. A product according to claim 5, wherein the observable parameter is selected from:
a) a characteristic of being one of curly and not curly; and
b) a characteristic of being one of wavy and not wavy.

7. A product according to claim 1, further comprising a third item of information representative of at least one parameter that is not associated with hair form.

8. A product according to claim 7, wherein the parameter not associated with hair form is representative of at least one of color and brilliance of the hair.

9. A product according to claim 1, wherein at least one of the first, second, and third items of information comprises an identifier.

10. A product according to claim 9, wherein the identifier includes at least one item from: an alphanumeric character; a symbol; a drawing; a color; and a bar code.

11. A product according to claim 10, wherein the identifier comprises at least one alphanumeric character having a form that is representative of hair form at least one of before and after treatment.

12. A product according to claim 11, wherein the alphanumeric character is selected from letters I, O, S and C.

13. A product according to claim 11, wherein the identifier further includes a number following the alphanumeric character.

14. A product according to claim 13, wherein the number is selected from: Arabic numerals; and Roman numerals.

15. A product according to claim 1, further comprising at least one analysis means for measuring at least one parameter associated with hair form.

16. A product according to claim 15, wherein the analysis means is included in a package with the hair-treatment composition.

17. A product according to claim 1, further comprising at least one set of instructions explaining how to measure at least one parameter associated with hair form.

18. A product according to claim 1, further comprising at least one support onto which hairs taken at different stages of a treatment using the product are secured to enable a user to observe an effect of the treatment.

19. A product according to claim 1, further comprising packaging for receiving a hair at least one of before and after treatment by said product, for sending to a remote analysis center.

20. A product according to claim 19, wherein the packaging includes pre-paid postage.

21. A product according to claim 1, further comprising at least two pictures of at least one of hairs and heads of hair and, in connection with said pictures, at least two items of information representative of at least one parameter associated with hair form.

22. A product according to claim 1, further comprising at least one of an electronic address of a web site and a telephone number of a server to which an image of at least one hair is to be sent.

23. A product according to claim 1, further comprising a composition for cleaning the hair before at least one of measuring and observing at least one parameter associated with the form thereof.

24. A range of products including at least first and second products, as defined in claim 1, the first product including a first item of information that is different from the first item of information of the second product.

25. A product comprising:
i) at least one hair-treatment composition; and
ii) at least one identifier in a form of at least one of an alphanumeric character and a graphic with a form representative of hair form from at least one of a head of hair for which said composition is suitable and a hair from a head of hair likely to be obtained after applying the composition.

26. A product according to claim 25, wherein the alphanumeric character is selected from letters I, O, S, and C.

27. A product according to claim 26, wherein the identifier includes a number associated with the alphanumeric character.

28. A product according to claim 27, wherein the number is selected from: Arabic numerals; and Roman numerals.

29. A product comprising:
at least one hair-treatment composition; and
at least one of:
at least a first item of information representative of at least one measurable parameter associated with a form of at least one hair from at least one of a head of hair for which said composition is suitable and a head of hair likely to be obtained after applying the composition;
at least one analysis means for measuring at least one measurable parameter associated with hair form;
at least two pictures of at least one of hair and heads of hair and, in connection with said pictures, at least two items of information representative of at least one parameter associated with hair form;
packaging for receiving a hair at least one of before and after treatment with the composition; and
at least one set of instructions explaining how to determine at least one parameter associated with hair form.

30. A product according to claim 2, wherein the hair-treatment composition comprises a hair styling gel.

31. A product according to claim 14, wherein the number is selected from 1 and 2.

32. A product according to claim 14, wherein the number is selected from I and II.

33. A product according to claim 15, wherein the at least one analysis means comprises at least one of a ruler and a gauge.

34. A product according to claim 28, wherein the number is selected from 1 and 2.

35. A product according to claim 28, wherein the number is selected from I and II.
